(19) United States
(12) Patent Application Publication
(10) Pub. No.: US 2025/0013989 A1
(43) Pub. Date: Jan. 9, 2025

(54) SYSTEMS AND METHODS FOR DYNAMIC MESSAGE HANDLING

(71) Applicant: JRNI, Inc., Boston, MA (US)

(72) Inventors: Yuan Cheng, Boxborough, MA (US); Kunal Jayant Mehta, Thane (IN); Ravi Dhirubhai Koshiya, Surat (IN); Pengcheng Luo, Belmont, MA (US)

(21) Appl. No.: 18/766,602

(22) Filed: Jul. 8, 2024

(30) Foreign Application Priority Data
Jul. 6, 2023 (IN) 202311045340

(51) Int. Cl. G06Q 10/1093; G06N 20/00

(52) U.S. Cl. CPC G06Q 10/1095; G06N 20/00

(57) ABSTRACT

The present disclosure provides a system having functionality that dynamic and interactive event scheduling. A message handler is provided to support automated message sequences, such as automated chat sessions and e-mail communications, in which the system exchanges messages with users in connection with scheduling or rescheduling events. A scheduling engine is provided to support creation and management of events, such as to create templates that may be used for event creation, as well as tracking attendance of events and other event-related information. A machine learning engine is provided to support analysis of messages exchanged between the system and users, where outputs of the machine learning engine may be used to identify optimal event parameters for events (e.g., optimal dates, times, locations, etc.)

### CROSS-REFERENCE TO RELATED APPLICATIONS

The present application claims the benefit of priority of Indian Provisional Application No. 20/2311045340 filed Jul. 6, 2023 and entitled “SYSTEMS AND METHODS FOR DYNAMIC MESSAGE HANDLING,” the disclosure of which is incorporated by reference herein in its entirety.

### TECHNICAL FIELD

The present application relates to scheduling processes and more particularly, to artificial intelligence driven processes for dynamic and interactive event scheduling.

### BACKGROUND

Computing devices presently used to support event scheduling are primarily designed to support trivial computational tasks. For example, during event scheduling a person may talk to an individual who may be interested in an event or may communicate with the person using another form of communication to obtain information associated with availability for attending an event. Once this information is obtained, the person may then manually type that information into a scheduling system. However, planning and tracking a large number of events in this manner, such as events across an enterprise, can be a time consuming and labor-intensive task involving many individuals, each requiring access to a computer and various forms of communication. It may also be difficult to enforce quality controls or standards for events across an entire enterprise, resulting in some entities of an enterprise hosting events that would otherwise be non-compliant with respect to enterprise policies or standards.

### SUMMARY

Embodiments of the present disclosure provide systems and methods that support automated techniques for dynamic and interactive scheduling of events. The disclosed systems include a machine learning engine, a message handler, and a scheduling engine, each providing different functionality associated with creating, scheduling, and tracking of events. For example, the scheduling engine may provide functionality for creating, managing and tracking events. The scheduling engine may enable creation of event templates that may be used to create events, which may enable standardization of event workflows and other aspects of event management in a standardized manner across an enterprise. The scheduling engine may also enable improved tracking of events, both in terms of tracking a confirmation status of event attendees, but also resources used to support planned events, such as hosting resource and availability of venues for events.

The message handler provides functionality for controlling communications to event attendees. For example, the message handler may receive inbound messages from individuals expressing interest in planned events. The messages may be received via a variety of communication mediums, such as interactive chat sessions, e-mail messages, or other techniques. As messages are received, the message handler may invoke various functionality of the machine learning engine to analyze the messages to determine recommendations for scheduling events. The message handler may utilize a set of templates to create outbound messages or prompts to the individuals based on the recommendations obtained via the machine learning engine. For example, the templates may include fields that may be populated with dates and/or times for scheduling an event, which may have been recommended by the machine learning engine based on analysis of an inbound message.

The machine learning engine may be used to optimize parameters for scheduling events. For example, the machine learning engine may utilize natural language processing to generate a set of tokenized data that may be ingested by one or more machine learning models to determine an intent of the individual (e.g., confirm attendance, reschedule an event, request to schedule a new event, etc.). Additionally, the machine learning engine may evaluate the information extracted from the message to determine a set of recommendations for an event. The set of recommendations may include event parameters determined to be optimal for the event, such as time, date, location, host, and other parameters of an event. The machine learning engine may be configured to validate the recommendations to ensure secondary considerations are accounted for, such as an ability to staff an event, event preferences, and the like. Where the set of recommendations are determined invalid, the machine learning engine may reconfigure the machine learning model(s) to generate a new set of recommendations for the event that accounts for the previous parameters determined to be invalid.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed methods and apparatuses, reference should be made to the implementations illustrated in greater detail in the accompanying drawings, wherein:

FIG. 1 is a block diagram illustrating an exemplary system in accordance with aspects of the present disclosure;

FIG. 2A is a block diagram illustrating a process for providing supporting operations to provide dynamic and interactive scheduling in accordance with aspects of the present disclosure;

FIG. 2B is a block diagram illustrating another process for providing dynamic and interactive scheduling in accordance with aspects of the present disclosure;

FIG. 3A is a block diagram illustrating aspects of providing dynamic and interactive scheduling in accordance with of the present disclosure;

FIG. 3B is a block diagram illustrating additional aspects of providing dynamic and interactive scheduling in accordance with of the present disclosure; and

FIG. 4 is a flow diagram illustrating an exemplary method for dynamic and interactive scheduling in accordance with of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

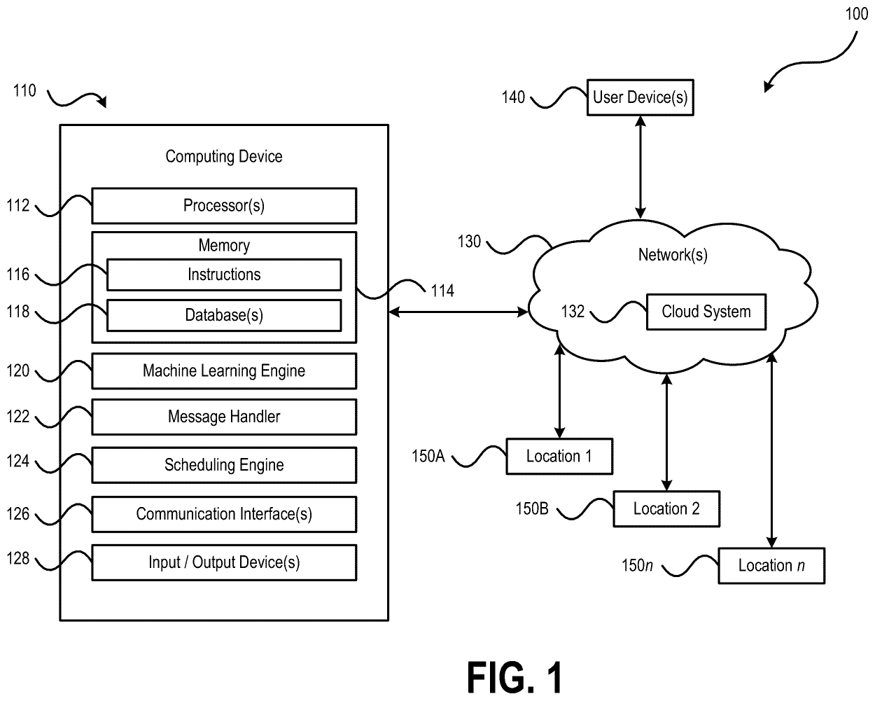

Referring to FIG. 1, a block diagram illustrating a system in accordance with aspects of the present disclosure is shown as a blockchain platform 100. In FIG. 1, the system 100 is shown as including a computing device 110 in communication with a plurality of user devices 140 via one or more networks 130. The user devices 140 may correspond to devices associated with users who are candidates for attending events scheduled in accordance with the techniques described herein, and may include personal computing devices, laptop computing devices, tablet computing devices, smartphones, personal digital assistants, smartwatches, and other computing devices capable of exchanging information with the computing device 110 in accordance with the concepts described herein. As described in more detail below, the computing device 110 provides functionality supporting creation of events (e.g., meetings, seminars, calls, video conferences, etc.) and automation of scheduling of attendance of the events by one or more attendees in a dynamic and interactive manner. In particular, the computing device 110 provides functionality for rapid creation of events using pre-defined templates. Once the events are created, the computing device 110 may automatically generate and transmit messages to potential attendees to schedule attendance of the events. The automated scheduling functionality leverages machine learning and artificial intelligence techniques to analyze responses to scheduling messages transmitted by the computing device 110 to determine whether an attendee is confirming attendance, requesting to reschedule attendance, inviting additional persons to attend the event, or other types of intent and context that may be extracted from the responses. The analysis of the responses may be used to automatically generate further messages to the candidate attendees, such as messages confirming dates and times for events attendees have confirmed their attendance for, determine alternative times for rescheduling the events based on information extracted from the responses using machine learning techniques, reminders associated with confirmed events, or other types of messages. The automatically generated messages created by the computing device 110 may create the appearance that the messages were created by humans, such as by creating quick replies in a chat-style session, or automatically replying to e-mails received from potential attendees. Additional details regarding the above-described functionality are described in more detail below.

The computing device 110 includes one or more processors 112, a memory 114, a machine learning engine 120, a message handler 122, a scheduling engine 124, one or more communication interfaces 126, and one or more input/output (I/O) devices 128. The one or more processors 112 may include one or more microcontrollers, application specific integrated circuits (ASICs), field programmable gate arrays (FPGAs), central processing units (CPUs) and/or graphics processing units (GPUs) having one or more processing cores, other circuitry and logic configured to facilitate the operations of the computing device 110, or a combination thereof in accordance with aspects of the present disclosure.

The memory 114 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the computing device 110 may be stored in the memory 114 as instructions 116 that, when executed by the one or more processors 112, cause the one or more processors 112 to perform the operations described herein with respect to the computing device 110, as described herein with reference to FIGS. 1-4. Additionally, the memory 114 may be configured to store information to one or more databases 118. Exemplary aspects of the types of information that may be stored in the one or more databases 118 are described in more detail below.

The one or more communication interfaces 126 may be configured to communicatively couple the computing device 110 to external devices and systems via the one or more networks 130, such as the user devices 140. Communication between the computing device 110 and the external devices and systems via the one or more networks 130 may be facilitated via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, an IEEE 802.16 protocol, a 3rd Generation (3G) communication standard, a 4th Generation (4G)/long term evolution (LTE) communication standard, a 5th Generation (5G) communication standard, and the like). The one or more I/O devices 128 may include one or more display devices, a keyboard, a stylus, one or more touchscreens, a mouse, a trackpad, a camera, one or more speakers, haptic feedback devices, or a combination thereof that enable a user (e.g., an individual responsible for creating events to be scheduled using the techniques described herein) to provide information to and receive information from the computing device 110.

The machine learning engine 120 may be configured to perform various types of analysis to facilitate operations to create and schedule events. For example, the machine learning engine 120 may include natural language processing functionality that may be used to extract features and scheduling parameters from messages exchanged between the computing device 110 and the one or more user devices 140 using the automated techniques described herein. The natural language processing functionality may include operations such as lemmatization and stemming, noise removal, sentence segmentation, tokenization, or other natural language processes.

The lemmatization and stemming functionality may be configured to remove suffixes from words, such as to remove “ing”, “ed”, or other suffixes from words present in the text. Sentence segmentation functionality may be utilized to divide the text into component sentences or phrases that may be suitable for analysis in connection with scheduling events. The noise removal functionality may be configured to process a set of input text (e.g., text included in a prompt or response exchanged in accordance with the concepts described herein) to remove terms that may not be useful for analysis in accordance with the context of the present disclosure. For example, the noise removal processing may remove hypertext markup language (HTML) tags, stop words (e.g., “a”, “an”, “the”, etc.), some punctuation marks (e.g., periods, commas, semi-colons, etc.), white spaces, uniform resource locators (URLs), and the like. It is noted that the noise removal may be specifically configured to handle some characters or terms differently based on the surrounding text. For example, a colon (“:”) in between numbers may represent a time for a proposed event, and therefore may provide relevant information associated with an event being scheduled. However, a colon surround by text may not be relevant to scheduling of an event and may be removed. In an aspect, a colon associated with a time may also be removed, but the time may be converted to a time format suitable for facilitating further analysis with respect to scheduling events. As a non-limiting example, the noise removal functionality may convert times to a 24-hour time format without a colon (e.g., convert 3:40 PM to 1540). The tokenization functionality may convert the text, which may include letters and numbers, into a set of tokens, where each token represents an individual word within the text. It is noted that the tokens may be represented as numeric values suitable for ingestion into one or more machine learning models of the machine learning engine 120. For example, as described below, the outputs resulting from the natural language processing may be provided to one or more machine learning models configured to identify an optimal time for scheduling or rescheduling an event, classification of an intent of the text (e.g., whether the text indicates an attendee is confirming attendance of an event, requesting to reschedule an event, declining attendance of an event, and the like), or other operations to facilitate automation of event scheduling in accordance with the concepts disclosed herein. In an aspect, the natural language processing may also include vectorization functionality to generate a vector representing the frequency of words within the text, which may be utilized for semantic analysis or other purposes (e.g., by a bag of words algorithm or other semantic analysis technique).

The machine learning engine 120 may also include one or more models and/or artificial intelligence algorithms configured to support the operations of the computing device 110 with respect to providing dynamic and interactive scheduling functionality in accordance with the present disclosure. For example, the machine learning engine 120 may include one or more machine learning algorithms configured to identify and match attendees for an event. As an example, if a customer wants to schedule a meeting with a service provider to discuss a service or product, the machine learning engine 120 may be configured to identify the right service personnel to meet with the customer. In matching the customer with the right service personnel, the machine learning algorithm may take into account not only the availability of the customer, which may be determined via the natural language processing functionality of the machine learning engine 120, but may also consider a service type to be provided during the meeting, the location of the meeting, the time the meeting is to occur, past appointment history, preference information associated with the customer (e.g., preferred location(s), preferred service(s), preferred appointment time(s), and the like), other types of information (e.g., potential value of the appointment, loyalty rewards level of the customer, historical communication and/or appointment history, and the like), or a combination thereof. Exemplary details for matching customers to service personnel are described in more detail below. As another example, the machine learning engine 120 may include one or more semantic analysis algorithms configured to analyze outputs of the natural language processing to determine an intent of text received during a dynamic and interactive scheduling session performed in accordance with aspects of the present disclosure. Additional exemplary aspects of the functionality provided by the machine learning engine 120 are described in more detail below.

The message handler 122 may be configured to provide functionality that supports the dynamic and interactive scheduling of events in accordance with the concepts described herein. For example, the message handler 122 may be configured to generate prompts for transmission to the user devices 140 (e.g., devices associated with potential attendees of events). The prompts may be generated based on pre-determined or pre-configured message templates, which may be stored in a templates database of the one or more databases 118. The pre-configured templates may include different types of templates according to various types of messages that may be provided while scheduling an event. For example, the templates may include one or more templates associated with an initial message associated scheduling an event, one or more templates associated with rescheduling an event, one or more templates confirming registration for an event, reminders associated with scheduled events, or other types of templates for messages. It is noted that there may be multiple templates for each different type of message to make the messages appear to have been written by a human, rather than always responding with the same message content for a given type of message.

Each of the templates utilized by the message handler 122 may include one or more fields that may be populated with information associated with scheduling an event. For example, an initial prompt to schedule an event may be populated based on a message received from, or information otherwise indicating a user is interested in attending an event. The prompts generated by the message handler 122 based on the templates may include one or more fields for personalizing a greeting, such as to insert the user's name (e.g., “Dear [User_X]” or “Hi [User_X]), one or more fields for providing event details (e.g., “Thank you for indicating your interest in [Event 1]. Would you be available on [Date]?” or “We confirm receipt of your message expressing interest in attending [Event 1] at [Location A]. Would you be available at [Time] on [Date]?”). It is noted that the exemplary templates and features for generating prompts described above have been provided for purposes of illustration, rather than by way of limitation and the message handler 122 may utilize other techniques (e.g., generative artificial intelligence models or algorithms) to generate messages in connection with dynamic scheduling of events in accordance with aspects of the present disclosure. In an aspect, the message handler 122 may also be configured to interact with the functionality provided by the machine learning engine 120 to extract information from messages received from users and determine information that may be used to populate the fields of the templates. Exemplary aspects of extracting information from messages using the machine learning engine 120 and using the extracted information to populate templates are described in more detail below.

The scheduling engine 124 may be configured to provide functionality that supports creation, scheduling, and tracking of events. For example, like the message handler 122, the scheduling engine 124 may be configured to utilize pre-configured event templates to enable users (e.g., event planners) to create events. The templates for creating events may be stored in an event templates database of the one or more databases 118 or may also be stored in the same database as the message templates used by the message handler 122. In an aspect, the event templates may be created at an enterprise level and may then be utilized by local instances of the enterprise to create events. For example, an enterprise may have a plurality of locations spread out over a geographic area (e.g., a city, state, country, continent, etc.). The event templates may be created at the enterprise level to ensure each local instance of the enterprise (e.g., a regional office, brick-and-mortar store location, etc.) uses consistent branding for events. The templates may also reduce the time required to create events and reduce the costs associated with event management.

In addition to utilizing templates to create events, the scheduling engine 124 may also be configured to coordinate with the message handler 122 and the machine learning engine 120 to optimize scheduling of events. For example, the scheduling engine 124 may utilize functionality of the machine learning engine 120 to identify times for conducting events in which sufficient personnel are available, and which are optimal for an individual or group of potential attendees for an event. The functionality of the machine learning engine 120 may also be used by the scheduling engine 124 to optimize other aspects of configuring, scheduling, and tracking events, such as optimizing locations for events, staffing events, durations of events, frequency of events, or other event related factors. Exemplary aspects of utilizing the functionality of the scheduling engine 124 and the machine learning engine 120 to optimize events are described in more detail below.

In an aspect, functionalities of the machine learning engine 120, the message handler 122, and the scheduling engine 126 may each be used during event scheduling operations. As briefly explained above, the message handler 122 may be configured to generate outbound messages or prompts to the user that include information associated with proposed or confirmed dates, locations, and times for events. At least a portion of the information included in the prompts may be derived using the functionality provided by the machine learning logic 120. For example, the message handler 122 may invoke the natural language processing of the machine learning engine 120 to extract intent information from a communication received from a potential event attendee using natural language processing and semantic analysis, as described above. The intent information may then be provided to a machine learning model provided by the machine learning engine 120 to classify the intent information, where the classification may then be used by the message handler 122 to determine a type of the prompt to use when generating a new message to the potential event attendee (e.g., a prompt related to rescheduling an event be selected or a prompt thanking the user for confirming attendance of an event).

Additionally, some of the information included in the prompts created by the message handler 122 may be obtained from the scheduling engine 124, which may utilize functionality provided by the machine learning engine 120 to optimize the scheduling information provided to the message handler 122. To illustrate, suppose a message is received indicating that a user is interested in attending an event that has been announced. The message handler 122 may detect that the user is interested in attending an event and select an appropriate template for generating a prompt for transmission to the user as described above but may utilize the scheduling engine 124 to determine the date and time that should be proposed for the event. The scheduling engine 124 may invoke one or more machine learning models of the machine learning engine 120 and apply the one or more models to information associated with the user and the event to obtain an optimized set of scheduling parameters that should be suggested to the user when attempting to schedule the event. In an aspect, the optimized set of scheduling parameters may specify a particular location for the event, which may be determined based on information associated with the specific user for which the prompt is being configured. For example, the machine learning model may predict the event should be scheduled at one of the locations 150A, 150B, . . . , 150n shown in FIG. 1 or a virtual location (i.e., video conference or telephone meeting). The optimized set of scheduling parameters may also include a proposed date and time for the event, which may be determined based on historical times and dates (and possibly locations) for prior meetings by the attendee. The message handler 122 may use the optimized set of scheduling parameters to populate scheduling data fields of the selected prompt template to produce a prompt that may then be transmitted to the user.

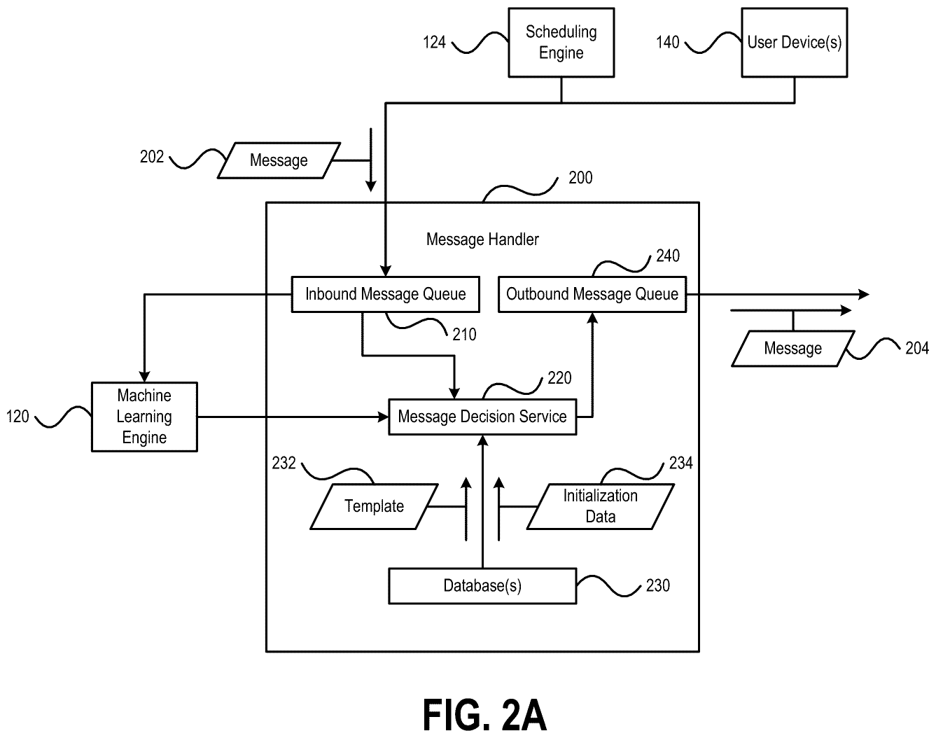

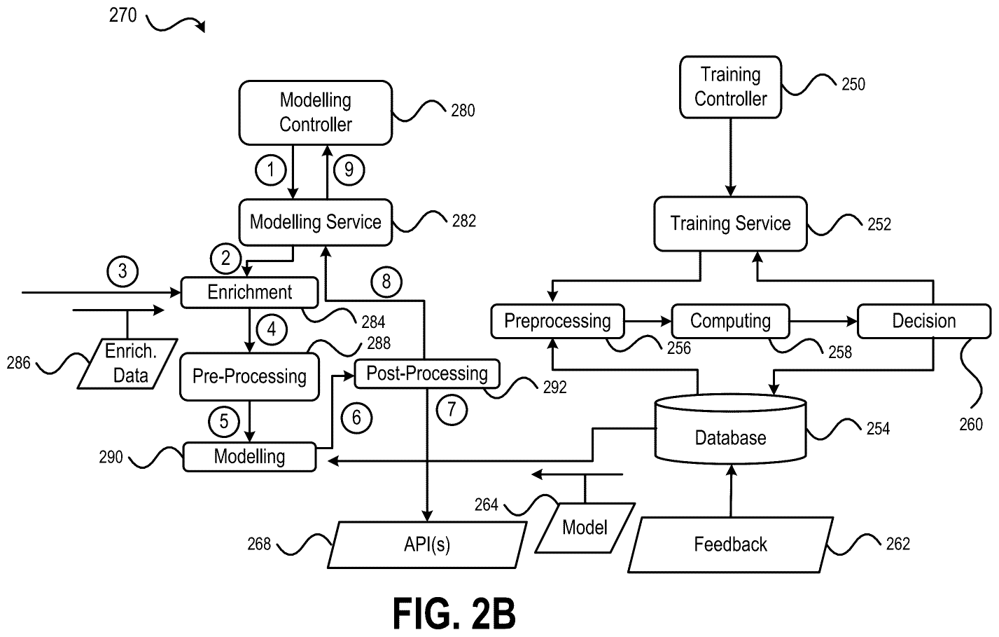

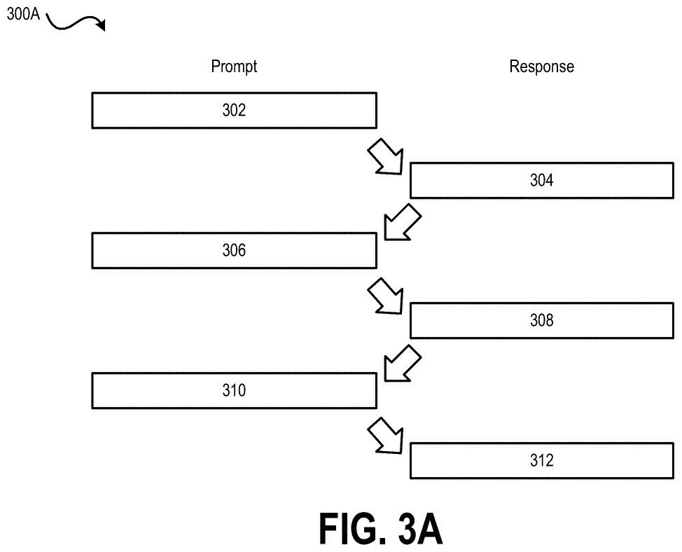

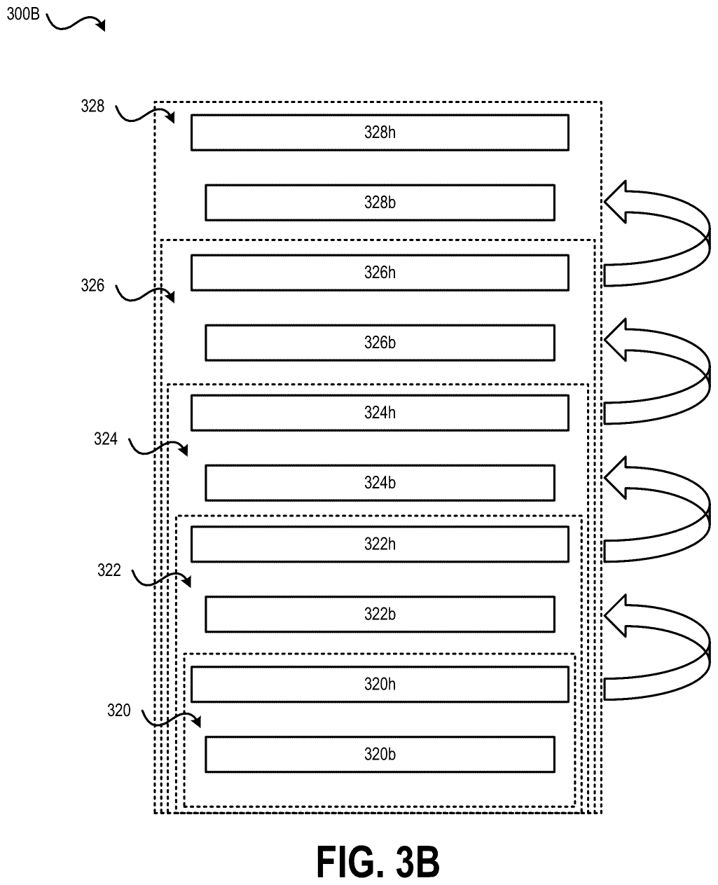

As explained briefly above and in more detail below, the messaging functionality provided by the message handler 122, along with support from the machine learning engine 120 and the scheduling engine 124, may be configured to support a variety of different communication mediums to support dynamic and interactive scheduling sessions with users. For example, as explained in more detail below with reference to FIGS. 3A and 3B, the message handler 122 may be configured to support a chat-style communication session or e-mail communication to schedule attendance of an event by a user. For example, the message handler 122 may include a large language model trained to function as a chat bot for performing scheduling of events based on scheduling parameters. Additionally or alternatively, the machine learning engine 120 may include the large language model. It is noted that the exemplary functionalities described above with reference to the machine learning engine 120, the message handler 122, and the scheduling engine 126 has been provided to give an overview of the types of functionalities that each of these components or modules provides. However, additional examples of these and other functionalities provided by these elements are explained in more detail in the examples and operations described below with reference to FIGS. 2A-4. Accordingly, it should be understood that the computing device 110 is not limited to the exemplary high-level operations described above and may perform any of the operations described below with reference to FIGS. 2A-4. It is also noted that while FIG. 1 illustrates the computing device 110 as being a standalone device, such as a server, a personal computing device, a laptop computing device, a tablet, or other type of computing device, the functionality provided by the computing device 110 may be provided via many different implementations, including a cloud-based implementation, shown in FIG. 1 as a cloud system 132.

Referring to FIG. 2A, a block diagram illustrating an exemplary message handler supporting dynamic and interactive scheduling in accordance with aspects of the present disclosure is shown as a message handler 200. In an aspect, the message handler 200 may be the message handler 122 of FIG. 1. Operations performed by the message handler may be stored as instructions (e.g., part of the instructions 116 of FIG. 1) that, when executed by one or more processors (e.g., the one or more processors 112 of FIG. 1), cause the one or more processors to perform operations described with reference to the message handler 200 (or the message handler 122 of FIG. 1).

As briefly explained above, the message handler may be configured to receive input data, shown as a message 202 in FIG. 2. The message 202 may be created and received in various ways. For example, a set of target attendees may be identified during configuration of an event, such as based on a database of users (e.g., a user database of the one or more databases 118 of FIG. 1). The database of users may contain information regarding users who have expressed interest in a topic associated with the event (e.g., based on a survey or other mechanism for capturing interests of users) or direct interest in the event (e.g., by indicating the event is of interest). As another example, the database of users may be generated (e.g., by the scheduling engine 124 of FIG. 1) based on past events and may record the names of each user that attended each past event. The database of users, regardless of how created, may also record information associated with a topic or topics associated with each past event, the date of the event, the location of the event (e.g., a particular city, building, office, or venue, including web-based venues), or other information about the events. When configuring the message 202 (e.g., during creation of a new event) the scheduling engine 124 may create a list of candidate attendees using the machine learning logic 120. For example, the scheduling engine 124 may pass information associated with the event (e.g., information about a topic or topics related to the event, a location for the event, a date and time for the event, or other information) to the machine learning engine 120.

The machine learning engine 120 may apply one or more artificial intelligence or machine learning techniques to the database of users to identify a set of candidate attendees believed to be likely to attend the event based on the information passed by the scheduling engine 120. For example, a clustering algorithm may be applied to the database to identify a set of users that have previously attended events in locations similar to one or more locations proposed for the event and which covered similar subject matter to the topic(s) associated with the event. The clusters generated by the clustering algorithm may include a cluster that identifies one or more users that are likely to attend the event, such as users that have attended similar events in the past. The users associated with that cluster may then be configured as target recipients for a prompt representing an invitation to the event. As non-limiting examples, the clustering algorithm may be a k-means algorithm, a centroid-based clustering algorithm, or another algorithm. Additionally or alternatively, the set of users to be targeted for the event may be identified using another machine learning technique or may be specified manually.

As shown in FIG. 2A, in some instances, the message 202 may be received from a user device 140, rather than from the scheduling engine 124. In such instances the message 202 may be a message generated in response to an inquiry by a user associated with the user device 140. For example, an event may be created and posted to a website or broadcasted out to a set of users via e-mail or another communication medium and may include a link that, upon activation by a user of the user device 140, may enable the user to send the message 202 to a computing device (e.g., the computing device 110 of FIG. 1) where it may be received by the message handler 200, where it may be analyzed using the machine learning engine 120 to extract intent and scheduling parameters, as briefly described above and in more detail below.

In FIG. 2A the message handler 200 is shown as including an inbound message queue 210, a message decision service 220, and an outbound message queue 240. Additionally, the message handler 200 may be communicatively coupled to one or more databases 230, which may be included in the one or more databases 118 of FIG. 1. The one or more databases 230 may include a prompt template database and the message handler 200 may be configured to retrieve prompt templates to be configured during a process for scheduling events.

As shown in FIG. 2A, the message 202 may be stored to the inbound message queue for processing when received by the message handler 200. When ready to process the message 202, the message handler 200 may pass the message 202 from the inbound message queue 210 to the machine learning engine 120. When passing the message 202 to the machine learning engine 120 the message handler 200 may include one or more commands that identify one or more machine learning algorithms to be applied to the message 202. The commands may include parameters for configuring the one or more machine learning algorithms to identify the information of interest. It is noted that details regarding operations of the machine learning engine 120 are not described in detail here and are instead described with reference to FIG. 2B.

The message handler 200 is shown as including a message decision service 220, which may be configured to receive outputs produced by the machine learning engine 120 when analyzing messages. The message decision service 220 may be configured to use insights and information included in the outputs of the machine learning engine 120 to configure messages to be transmitted to users in connection with scheduling events. For example, the message decision service 220 may be configured to use the outputs of the machine learning engine 120 to determine a prompt template from the database(s) 230 (e.g., a prompt template database). To illustrate, where the output of the machine learning engine 120 indicates a user has requested information about an event, the message decision service 220 may select a prompt template associated an introductory message to the user regarding the event. However, if the output of the machine learning engine 120 indicates the user is requesting to reschedule an event, a prompt template may be retrieved that is appropriate for a message rescheduling the event for the user. As additional non-limiting examples, the prompt templates database may include prompt templates associated with messages to confirm scheduled events, to remind a user about a scheduled event, or other types of prompt messages.

In addition to using the outputs of the machine learning engine 120 to select a prompt template, the message decision service 220 may also utilize the outputs of the machine learning engine 120 to configure scheduling data within fields of the selected prompt template. For example, as explained in more detail below, the machine learning engine 120 may extract scheduling parameters during analysis of the message 202. The scheduling parameters may include a date and time proposed by the user in the message 202 for the event. It is noted that the scheduling parameters may be specific or concrete parameters, such as to indicate a specific day and time (e.g., Jun. 30, 2023, at 3:30 PM CST) or may be relative or vague parameters, such as to indicate a general day and time (e.g., middle of next week, end of the month, early next month, next few days, etc.).

Where the scheduling parameters are concrete, the message decision service 220 may incorporate the scheduling parameters into the selected prompt template. However, where the scheduling parameters are relative, the message decision service 220 may utilize the functionality of a scheduling engine (e.g., the scheduling engine 124 of FIG. 1) to resolve the relative parameters into concrete parameters that may be suitable for incorporation into the selected prompt template. Exemplary techniques for resolving relative scheduling parameters are described in more detail below. In an aspect, the message decision service 220 may pass initialization data 234 to the scheduling engine 124 in connection with resolving relative scheduling parameters. For example, the message decision service 220 may retrieve information associated with the user or users corresponding to the message 202 and may pass that information to the scheduling engine 124. When provided to the scheduling engine 124, the initialization data 234 may be provided to the machine learning engine where it may be provided to one or more machine learning algorithms, which may use the initialization data 234 to tailor the scheduling parameters to the user or users for which the message decision service 220 is configuring prompts.

Once the prompts have been configured by the message decision service 220, the prompts may be provided to an outbound message queue 240, which may be configured to temporarily store the configured prompts. A configured prompt, once stored in the outbound message queue 240, may be transmitted to the user device(s) 140 (e.g., via the communication interface(s) 126 and the one or more networks 130 of FIG. 1) as a message 204. As explained above and illustrated with reference to FIGS. 3A and 3B, the message(s) 204 may be provided to the user devices via a variety or communication techniques or mediums, such as an interactive chat session or a sequence of e-mails (e.g., the message handler 200 may transmit a reply e-mail to a user when an e-mail is received, as a message 202, from a user device 140).

As shown above, the message handler 200 provides functionality for automatically generating messages that may be used to schedule events to be attended by one or more users. By providing the messages 204 to the user via an interactive chat session or as part of an e-mail sequence, the user may perceive that the messages 204 are being created by a human despite the messages 204 being automatically configured by the message handler 200. Also, as previously explained, the prompt template database may store multiple different templates for each different type of message 204 (e.g., messages associated with inviting users to an event, rescheduling events, cancelling events, reminding users about events or changes to the events, confirming attendance of an event, or other types of messages). Providing different message templates may also improve the ability of the messages created by the message handler 200 to create the appearance that the messages 204 are being generated by a human, rather than in an automated manner driven by machine learning and pre-configured templates. The message handler 200 also provides functionality to support scalability of the system 100 of FIG. 1, such as to enable event scheduling to be performed in an automated manner despite potentially needing to transmit thousands, tens of thousands, hundreds of thousands, or even millions of messages per day, which may involve events covering diver and geographically disparate locations around the world.

Referring to FIG. 2B, a block diagram illustrating an exemplary machine learning engine supporting dynamic and interactive scheduling in accordance with aspects of the present disclosure is shown as a machine learning engine 270. In an aspect, the machine learning engine 270 may be the machine learning engine 120 of FIGS. 1 and 2A. Operations performed by the machine learning engine 270 may be stored as instructions (e.g., part of the instructions 116 of FIG. 1) that, when executed by one or more processors (e.g., the one or more processors 112 of FIG. 1), cause the one or more processors to perform operations described with reference to the machine learning engine 270 (or the machine learning engine 120 of FIG. 1).

In the examples above it was explained that the machine learning engine 270 may be configured to use natural language processing, machine learning models, and artificial intelligence algorithms to support scheduling of events during dynamic and interactive sessions between a system (e.g., system 100 of FIG. 1) and one or more user devices (e.g., the one or more user devices 140 of FIGS. 1 and 2A). Exemplary natural language processing algorithms have been described above and are not repeated here for conciseness of the disclosure. The one or more machine learning models and artificial intelligence algorithms may include classifiers, clustering algorithms, neural networks, and the like, which may be used to support scheduling of events. For example, after extracting features and scheduling parameters from a set of input data, as explained above with reference to FIGS. 1 and 2A, the outputs of the natural language processing algorithms may be provided to a classifier that has been trained to classify an intent of the input data. Examples of various types of intent that may be extracted from input data are described below with reference to Table 1. Additionally or alternatively, other techniques may be used, such as a bag of words algorithm or another technique suitable to extract intent features and parameters from the input data.

Additionally, the machine learning algorithms may include one or more models that have been trained using historic scheduled event data to identify users that are likely to attend events. For example, clustering algorithms may be trained to group users based on one or more metrics (e.g., topics associated with events, locations of events, times of events, etc.) to enable the algorithms to group users into different groups according to the one or more metrics. Such clustering techniques may produce clusters that identify groups of users that may share a similar interest in a particular topic and therefore, may be candidate attendees for an event covering that topic. Using the clustering techniques in this manner may enable a system operating in accordance with the present disclosure to generate targeted campaigns for broadcasting (e.g., via messages 204 of FIG. 2A or other techniques) notifications and information about upcoming events to users that are likely to be interested in the events, thereby utilizing computing resources of the system in an optimized manner (e.g., requiring reduced computing resources, such as processing power, memory requirements, and the like) that improves event outcomes (e.g., registrations, attendance, etc.) as compared to prior techniques. For example, targeting such notifications about upcoming events to only those users predicted to have an actual interest in the event or be likely to attend the event may reduce network bandwidth utilization and reduce unneeded traffic on a web server or other elements of a communications network or system (e.g., the system 100 of FIG. 1).

In addition to using the machine learning algorithms to identify users (e.g., potential event attendees) that are likely to attend planned events, the machine learning algorithms may also be utilized to optimize other aspects related to planned events. For example, the machine learning algorithms may be configured to predict a type of event each potentially interested user may be most likely to attend, such as to predict whether an event should be promoted to a user via a first type of event (e.g., an in-person meeting or visit) or a second type of event (e.g., a telephone call or web conference). Using such a machine learning capability may enable a single planned event to be promoted to each targeted user (e.g., users within a cluster identified as being interested in the event) in a user-specific manner, which may further improve the efficiency with which events are planned.

The machine learning models may also be trained to identify optimal times and/or locations for events. To illustrate, a machine learning model may be trained to identify a venue or location for an event that is optimized for each individual user. In such a scenario the machine learning model (e.g., a neural network) may receive information about the event and a user and may output a set of probabilities, where each probability of the set of probabilities is associated with a different location where the event may occur and indicates a likelihood the user will attending the event if hosted at the corresponding location. Such information may enable an optimal venue for events to be determined on an individual user basis and increase the likelihood that the event is successful and well attended. It is noted that in some instances multiple users may be invited to a single event, while in other instances events may be personalized for different individual users. Similar functionality may be provided by a model configured to determine an optimal time for each event on a user-by-user basis. For example, a machine learning model may be configured to predict a likelihood of a user attending an event at different times, where the time with the highest likelihood of attendance (or multiple times having high likelihoods of attendance) may be proposed to a user for a given event. As explained herein, event types, locations, and times may be provided as scheduling parameters to a message handler (e.g., the message handler 122 of FIG. 1 or 200 of FIG. 2A) for incorporation into outbound prompt messages.

The machine learning engine may also include one or more machine learning models configured to optimize event staffing. For example, a machine learning model may be configured to predict optimal levels of service personnel to host or staff a scheduled event. The predicted levels of service personnel may be based on the number of attendees, the location or venue, a type of the event, and historical interactions with potential attendees of the event. For example, the machine learning model(s) may be configured to analyze staffing information to determine available staff at the time of an event, as well as the number of attendees for the event, whether the attendees have previously interacted with any of the available staff, a number of events planned at the same time as or near in time to the planned event, or other factors. Where the event is a private event for a single customer, such as a showing of jewelry or other high-end items to a potential buyer, the machine learning model may predict one or more sales persons that may be the best fit for attending the event with the buyer, such as a sales person that the buyer has purchased from before.

As another non-limiting example of using machine learning models to evaluate staffing of events, the machine learning engine may include one or more machine learning models configured to analyze scheduling data (e.g., data associated with events scheduled at one or more candidate locations on a particular day) to determine whether an event should be rescheduled for a different day (e.g., a day with less events scheduled, more staff available, etc.). To illustrate, suppose that an optimal location for hosting an event for a particular user has a large number of events scheduled on Wednesday and Friday, but few events scheduled on Thursday. A machine learning model may be trained to detect that scheduling an additional event on Wednesday or Friday may result in poor service during the event (e.g., due to the large number of events already scheduled on those days) and may predict that moving the event to Thursday would be optimal (e.g., since there are no or few events scheduled that day). Additionally or alternatively, a machine learning model may be configured to identify available staff for hosting events that are not currently scheduled and may recommend scheduling the additional staff to provide additional capacity to service the events scheduled on Wednesday and Friday, which may be beneficial if those are days the user has indicated they are available. Additional examples of the types of analysis performed by the models and algorithms of machine learning engines in accordance with aspects of the present disclosure are described in more detail below.

As shown in FIG. 2B, the machine learning engine 270 may include a training controller 250 that controls a training service 252 that may be used to train the one or more machine learning models of the machine learning engine 270. A machine learning database 254 (e.g., one of the databases 118 of FIG. 1) may be provided to store training datasets for use in training each of the one or more machine learning models. The training datasets may include historical event data, historical messages exchanged between users (i.e., event attendees) and a scheduling system (e.g., the system 100 of FIG. 1), information associated with available event locations, information associated with a list of services that may be provided during events, event host data (e.g., information associated with individuals of an entity that conduct interactions with the user(s) during scheduled events), other types of data (e.g., information regarding a method of transmitting messages to the user to schedule an event, such as using the chat-style messaging technique or e-mail, as described herein), or a combination thereof. In an aspect, the training datasets may also include sales data, which may include information regarding a salesperson that attended an event, a customer that attended the event and made a purchase from the sale person, the sales amount, the sales date, item(s) purchased, a time of the purchase, and the like.

The training service 252 may be activated or controlled via the training controller 250 to perform training of the one or more machine learning models based on the training data stored in the database(s) 254. For example, the training service 252 may implement a training process that includes the following elements: a preprocessing step 256, a computing step 258, and a decision step 260. The preprocessing step 256 may be configured according to control information provided to the training service by the training controller 250, such as to retrieve a model from the database(s) 254 for training and a set of training data. Once the model and training data have been obtained, the preprocessing step 256 may divide the training data into a training dataset and a validation dataset, where the training dataset includes a portion of the training data that is to be used to train the model, and the validation dataset includes a different portion of the training data that is to be used to verify how the model is performing as a result of the training.

At the computing step 258, the training dataset is used to perform training of the model. In an aspect, the training may be performed over multiple iterations. For example, the model may be trained multiple times using different portions of the training dataset. The training may be performed in a supervised or unsupervised manner depending on the particular model being trained and the configuration of the training. In an aspect, the training dataset may include at least some labeled training data, where the labels identify the desired outcome that the model should predict or output for the data corresponding each label. In an additional or alternative aspect, the training dataset may not include labeled training data, which may be reserved for validation of the model performance once sufficient training has been performed. At the decision step 260, the validation dataset may be used to verify the performance of the model, such as to determine an accuracy metric with respect to outputs of the trained model when provided with at least a portion of the validation dataset. Alternatively, the validation dataset may be processed using the trained model following a desired number of training cycles or after each training cycle to determine whether the model is ready for use in scheduling events or if additional training is needed. In an aspect, training may be determined to be complete (i.e., the model(s) is ready for use in scheduling events) when the performance of the trained model satisfies a threshold performance level (e.g., 80%, 85%, 90%, 95%, or 95%+ accuracy with respect to predicted outputs or another performance metric that indicates how well the model is able to interpret input data and provide appropriate output).

Where the model is determined to satisfy the threshold level of performance, the model may be stored in the one or more databases 254 for subsequent use in scheduling events, as described further below. If the model is determined, at decision step 256, to not satisfy the threshold level of performance, additional training may be performed. As a non-limiting example, where the outcome determined by the decision step 256 indicates further training is needed (e.g., because the model or algorithm performance does not satisfy a threshold level of performance) despite having performed a particular number of training cycles, the decision step 256 may provide information to the training service 252 to indicate that additional training is needed, which may cause the training service 252 to trigger one or more additional training cycles. When additional training is performed, a new set of training data may be obtained from the database(s) 254. The new set of training data may be the same as or similar to the training data used during the prior training cycles, but the split between the training dataset and the validation dataset may be different, thereby resulting in a different set of training data for the new training cycle(s). This process may be repeated until the performance of the model(s) reaches a satisfactory level and is ready for deployment.

It is noted that further training may be performed on a periodic basis even after any of the models are trained to meet or exceed the threshold level of performance. Such additional training may be based on feedback 262, which may be periodically stored to the one or more databases 254. For example, where a model is trained and determined ready for use in scheduling events, the feedback 262 stored in the database(s) 254 may include information obtained or generated by the model(s), such as one or more messages 202, 204. It is noted that the feedback 262 may include data that may be selected as training data for multiple different types of models. For example, the feedback 262 may include information that may be used to train a model to more accurately cluster users, classify intent, identify optimal times for scheduling events, predict optimal dates for events, predict optimal staffing or staffing changes for events, and the like. By continuously recording feedback 262 corresponding to operations of an event scheduling system and then using the feedback 262 for additional training, the machine learning models and artificial intelligence algorithms may become even more accurate with respect to predictions and outputs over time, resulting in further enhancements and efficiencies with respect to scheduling of events.

As shown in FIG. 2B, the machine learning engine 270 may include a modelling controller 280. The modelling controller 280 may be configured to manage requests to apply natural language processing and machine learning models and algorithms to datasets and may provide outputs of the machine learning algorithms to relevant system elements. For example, the modelling controller 280 may be configured to receive information from a message handler (e.g., the message handler 122 of FIG. 1 or the message handler 200 of FIG. 2A) in connection with evaluating messages received in connection with scheduling events. Additionally, the modelling controller 280 may be configured to receive requests from a scheduling engine in connection with identifying optimal times for scheduling events, optimal locations for scheduling events, and the like.

When a request to utilize the functionality of the machine learning engine 270 are received, a modelling service 282 may be invoked to initiate analysis of the request. To facilitate analysis of the request, the modelling service 282 may perform an enrichment process 284 to obtain additional information that may be utilized to improve the outputs obtained via a machine learning model or algorithm. For example, where the request is associated with scheduling (or rescheduling) an event, the enrichment process 284 may obtain enrichment data 286 to provide additional context associated with the request being processed. For example, the enrichment data 286 may be obtained by the enrichment process from one or more databases (e.g., the one or more databases 118 of FIG. 1, the one or more databases 230 of FIG. 2A, or another database). It is noted that the enrichment process 284 may be utilized when applying certain types of machine learning models or algorithms and may be skipped when using others. For example, when applying a clustering algorithm, the information obtained via the enrichment process may enable the clustering algorithm to more accurately compare the request to historical data to find a group of similar requests from which insights may be determined and used to handle the request.

As a non-limiting example, suppose the request being processed is a request to schedule or reschedule an event. Where the enrichment process 284 is used, the enrichment data 286 may include client relationship management (CRM) data, event booking data (e.g., data associated with past or future events), historical data, or other types of data that may be used to provide additional context associated with the request. The CRM data may include information associated with a customer for which the event is being scheduled (e.g., the customer's location, salespersons the customer has worked with, purchase history, etc.), the event booking data may include a list of past events the customer attended or future events the customer is scheduled to attend, and the historical data may include all historical booking data (e.g., event booking data for other customers). The enrichment data 286 may be passed to the clustering algorithm with information from the request, and the clustering algorithm may perform clustering to create clusters in which similar historical event bookings are grouped together. Features of the request may then be determined to be closest to one of the clusters, which may provide insights that may be used to predict one or more recommended features for scheduling or rescheduling the event, such as a recommended time or location for the event, a recommended venue for the event (e.g., a particular store location, office location, a virtual location, etc.), or other scheduling features.

In a situation where another machine learning technique is used, the enrichment data 286 may not be needed and may be omitted. For example, suppose that a machine learning algorithm (e.g., a neural network) is trained to accept the information of the request as input and output a set of probabilities associated with event parameters (e.g., locations, times, etc.). In such a scenario, rather than obtaining the enrichment data described in the example above where a clustering algorithm was applied, the information of the request may be provided to the machine learning algorithm without the enrichment data. Using either of the above-two described algorithms, a set of recommended parameters for scheduling or rescheduling an event with the customer may be obtained.

To perform analysis using the concepts described above, the data of the request and any applicable enrichment data obtained by the enrichment process 284 may be subjected to pre-processing operations 288. The pre-processing operations 288 may include natural language processing, as described above. Additionally, the pre-processing operations 286 may include normalization of one or more portions of the data from the request and/or the enrichment data 286. Normalization operations may include cleaning data to remove missing values, converting data to defined values, removing portions of the enrichment data (e.g., records in which some values are missing), or other types of operations.

Once pre-processing operations 288 are completed, the pre-processed data may be provided to a modelling process 290 in which a model 264 may be applied to the pre-processed data. For example, the model 264 may be a model that was trained using the above-described training process and may be obtained from the one or more databases 230. As explained in the numerous examples herein, the modelling process 290 may be capable of applying a variety of machine learning models and algorithms to the pre-processed data, where the models or algorithms applied to a given set of pre-processed data may depend on a type of the request. For example, a request from a user to schedule an event may utilize a first model or first set of models, but a request to reschedule the event may utilize a different model or set of models. To illustrate, when initially determining an event configuration for scheduling the event, a clustering algorithm may be used to determine one or more features associated with the event, such as information associated with a venue or location for the event, and a second model or algorithm may be used to determine an optimal date and/or time for the event. When rescheduling the event, the clustering algorithm may not need to be applied because the optimal venue or location for the event has already been determined, and so only the second model or algorithm may be used to reschedule the event to a new date and/or time.

In an aspect, an ensemble of models may be applied during the modelling process 290. For example, a clustering algorithm may be used to determine a first set of features predicted to be optimal for the event, a second model may be used to optimize the date and/or time for the event, and a third model may be utilized to optimize event hosting parameters, such as to select a particular event host. As another example, a model may be trained to predict whether a level of service for the event will satisfy a threshold level of service (e.g., a level of service indicated in the enrichment data 286 or based on other factors) if hosted on a predicted date and/or time output from another model. If the level of service does not satisfy the threshold level of service, the model may trigger reevaluation of the predicted date and/or time for the event and may pass the model determining the date and/or time parameters to indicate the previously predicted date and/or time is not optimal.

Once the modelling operations 290 are complete, a set of post-processing operations 292 may be applied to the outputs of the model(s). The post-processing operations 292 may be configured to evaluate the outputs of the model(s) and generate appropriately formatted data for use in scheduling events. For example, the post-processing operations 290 may evaluate a set of probabilities output by a neural network to identify the optimal (e.g., highest probability) recommendation generated by a machine learning model. The optimal recommendation(s) may then be output(s) to the modelling service 282, which may in turn return the recommendation(s) to an appropriate element of the system (e.g., the message handler 122 or 200 of FIGS. 1 and 2), a scheduling engine 124 (e.g., the scheduling engine 124 of FIG. 1), or other element.

In an aspect, the post processing operations 292 may also trigger additional workflows and modelling processes. For example, when a recommendation for scheduling an event is received, the post-processing operations 292 may utilize one or more application programming interfaces (APIs) 292 to verify availability of a host for the event. If a host is not available based on information obtained from the APIs 292, a second optimal recommendation may be selected, and host availability may be performed for that recommendation. In an aspect, verification of host availability may be performed up to a threshold number of times before the post-processing operations 292 may determine that a new recommendation is needed. For example, if the recommendation verification process is performed 3 times without success, the post-processing operations 292 may determine that a new set of recommendations may be needed and may initiate a new modelling process (e.g., process to evaluate the request data using the model(s)). The post-processing operations 292 may provide a set of negative parameters for use in the new modelling process, such as to indicate a set of dates and/or times is not viable. These negative parameters may be used to eliminate the previous recommendations for which validation was unsuccessful, thereby resulting in a new set of optimized recommendations that are different. The above-described recommendation validation process may be performed iteratively until a viable set of optimal recommendations is obtained, which may then be used for scheduling the event (e.g., by passing the recommendations to the message handler for further processing).

In an aspect, the recommendations output by the modelling engine 270 may include multiple event scheduling options. For example, the event scheduling options may propose two dates and/or times at which the event may be scheduled. Using these dates and/or times, the message handler may generate an appropriate message to the user. Enabling multiple dates and/or times to be proposed may be beneficial as it provides the user with flexibility for scheduling the event and may increase the likelihood that the event is scheduled or confirmed. In an aspect, the number of alternative dates and/or times proposed in a message may be restricted by a user or the event host, such as through configuration of event scheduling parameters of the system.

Where multiple dates and/or times are permitted, the recommendation validation operations may be configured to validate each of the alternative recommendations to verify host availability. In some aspects, the event scheduling parameters may include specific host preferences, which may enable users to indicate a preference for one or more hosts to be present at the event. Where such parameters are configured, the post-processing operations 292 may validate that at least one of the hosts designated in the event scheduling parameters is available and may initiate additional workflows for any events that are not validated. In a situation where one or more of the alternative dates and/or times are determined valid, but others are not, the post-processing operations 292 may trigger re-evaluation of the data using the modelling processes described above and may provide positive parameters, which may indicate any confirmed optimal recommendations. Where such positive parameters are configured, the re-evaluation of the data may seek to only identify any remaining non-confirmed recommendations. For example, if 3 alternative dates and/or times are indicated in scheduling preferences, and 2 of the recommendations from the initial run of the modelling processes are validated, the second cycle of modelling operations may be used to generate a set of additional recommendations from which the final recommendation may be selected upon validation.

Exemplary scheduling preferences that may be configured by users may include preferred events (e.g., types of services, types of events, topics for events, etc.), preferred event locations, host preferences (e.g., preferred event hosts), preferred event times, preferred service levels, or other parameters. In additional or alternative aspects these parameters may be inferred by the system. For example, after each event the user may be sent a survey and feedback about the event may be obtained. The feedback may be analyzed using a machine learning model using similar processes to those described above to determine each users' preferences, which may then be recorded to a database for subsequent use in scheduling events.

In an aspect, the post-processing operations 292 may be configured to identify the optimal recommendation(s) based on a variety of optimization factors. For example, the optimization factors may include lead time (e.g., earliest available date and/or time), balancing of resources (e.g., ensuring appropriate event host availability to provide minimum level of service), value, availability (e.g., of a product, service, service level, etc.), or other optimization factors. Multi-dimensional optimization using combinations of these optimization factors may also be used.

To further illustrate the exemplary operations, examples of messages that may be received and operations to process those messages to schedule or reschedule events are described in more detail below with reference to Table 1:

TABLE 1

| | New | Scheduling | Other | Time | | |
|---|---|---|---|---|---|---|
| Content | Intent | Intent | Intent | Zone | Date | Time |
| Are you available at 5 | Request | Reschedule | | Default | said date | 17:00 |
| pm to discuss the | | | | | | |
| changes to the deck? | | | | | | |
| Thanks. | | | | | | |
| Will move to 7:15 to | Request | Reschedule | | Default | said date | 7:15 |
| clump all calls | | | | | | |
| together. | | | | | | |
| Good morning - I | Remind | Remind | | Default | Feb 1st | 9:00 |
| hope you all are doing | | | | | | |
| well. This is just a | | | | | | |
| reminder of the call | | | | | | |
| scheduled for next | | | | | | |
| Wednesday, February | | | | | | |
| 1st at 9 am. | | | | | | |
| Sorry. I am traveling | Request | Reschedule | | Default | Mid | |
| and can we catch up in | | | | | December | |
| mid December? | | | | | | |
| I will be traveling next | Confirm | Confirm | | Default | Tuesday | said time |
| week but will be | | | | | | |
| zoomed in on Tuesday | | | | | | |
| for our meeting. | | | | | | |
| I'm out of office and | Other | No Action | | | | |
| traveling with limited | | | | | | |
| access the week of | | | | | | |
| December 19th. I will | | | | | | |
| respond to messages | | | | | | |
| intermittently | | | | | | |
| throughout the week. | | | | | | |
| Thank you for the | Request | Reschedule | | Default | Early | |
| note. John is | | | | | December | |
| travelling overseas so | | | | | | |
| an intro call may be | | | | | | |
| best in early | | | | | | |
| December. We'll | | | | | | |
| check-in towards the | | | | | | |
| end of the month and | | | | | | |
| see if we can find | | | | | | |
| some time for an intro | | | | | | |
| call. | | | | | | |
| How about next | Request | Reschedule | | Default | Next Thursday | |
| Thursday afternoon? | | | | | or Wednesday | |
| Or Wednesday? | | | | | | |
| Works for me. | Confirm | Confirm | | | | |
| Happy to meet with | Confirm | Confirm | | | | |
| him as well. | | | | | | |
| Oct 20 (Thu) 11:00 | Confirm | Confirm | Questions | PST | Oct 20 | 11:00 |
| AM PST works for | | | | | (Thu) | |
| me. To make this call | | | | | | |
| more focused and | | | | | | |
| productive I have a | | | | | | |
| few questions, if you | | | | | | |
| can answer those in | | | | | | |
| advance, it will be | | | | | | |
| helpful. | | | | | | |
| Thanks Dennis and | Decline | Decline | | | | |
| PK. I am traveling | | | | | | |
| today and will not be | | | | | | |
| able to participate. | | | | | | |
| He has proposed some | Request | Reschedule | | PST | Oct 17 to | 11:00 AM |
| times for a meeting | | | | | Oct 21 | or 3:00 PM |
| October 17-21 | | | | | | |
| (Between 11:00 AM | | | | | | |
| PST & 3:00 PM PST) | | | | | | |
| to discuss potential | | | | | | |
| investment | | | | | | |
| opportunities. Please | | | | | | |
| let me know what | | | | | | |
| works best on your | | | | | | |
| end and I will set it up. | | | | | | |
| Thursday at 2 pm | Confirm | Confirm | | Default | Thursday | 14:00 |
| works for Greg & I. | | | | | | |
| Looking forward to it! | | | | | | |
| Unfortunately, Eric is | Other | NoAction | | | | |
| at an offsite this week | | | | | | |
| I apologize for the | Request | Reschedule | | | | |
| last-minute notice but | | | | | | |
| I'm going to | | | | | | |
| reschedule our call. | | | | | | |
| We are going to delay | Request | Reschedule | | | next week | |
| this call. Will | | | | | | |
| reschedule in the next | | | | | | |
| few weeks. | | | | | | |
| Does August 9 work | Request | Reschedule | | Eastern | 9-Aug | after |
| for your team? I can | | | | | | 11 AM |
| move my calendar to | | | | | | |
| be available anytime | | | | | | |
| after 11 AM Eastern. | | | | | | |
| 8:30 am EST | Other | No Action | | | | |
| tomorrow might work, | | | | | | |
| I need Carolina to | | | | | | |
| confirm her | | | | | | |
| availability when she | | | | | | |
| is online. | | | | | | |
| I am on a personal | Other | No Action | | | | |
| leave on 1 Mar. | | | | | | |
| 2023 and will have | | | | | | |
| very limited access to | | | | | | |
| my emails. I will reply | | | | | | |
| to your email after | | | | | | |
| resuming office on 2 | | | | | | |
| Mar. 2023. | | | | | | |
| I am out of office till | Request | Reschedule/ | | | | |
| 5th may. Please | | Others | | | | |
| contact later or reach | | | | | | |
| out to | | | | | | |
| user@example.com | | | | | | |

To obtain the classification the machine learning engine may utilize natural language processing techniques to extract semantic information that indicates the context of any received responses or sent prompts. For example, the prompt “Are you available at 5 μm to discuss the changes to the deck? Thanks.” in Table 1 above may be analyzed to extract the following features: a new intent (e.g., “Request”), a scheduling intent (e.g., “Reschedule”), and scheduling parameters that indicate prompt is requesting to reschedule a meeting for “said date” (i.e., today) at 5:00 PM (17:00), where the time is specified based on a default time zone. Similarly, a message of “Will move to 7:15 to clump all calls together.” may be analyzed using the natural language processing of the machine learning engine to extract features that indicate a request to reschedule a previously scheduled meeting (or meetings) to 7:15 PM.

It is noted that Table 1 also illustrates additional types of prompts and responses that may be detected using the natural language processing functionality of the machine learning engine. For example, the prompt “Good morning—I hope you all are doing well. This is just a reminder of the call scheduled for next Wednesday, February 1st at 9 am.” represents a prompt provided to remind one or more users of an event scheduled for Wednesday, February 1st at 9 AM. In an aspect, the message handler may be configured to periodically transmit such reminders to users associated with scheduled events. The reminders may be configured for transmission based on one or more configurable parameters, such as a reminder parameter configured by a host of the event and/or reminder parameters configured by a user scheduled to attend the event. As a non-limiting example, when configuring an event for which scheduling will be performed according to the techniques disclosed herein, one or more reminder parameters may be configured by a user (e.g., event planner or coordinator) to control how reminders are sent to participants. The one or more reminder parameters may include parameters to control transmission of reminders to participants that are scheduled to attend the event, such as to remind them 1 week before, 2 days before, the day of the event, or combinations thereof. Similarly, the one or more reminder parameters may include reminders to prospective event participants to remind them of the event and prompt them to confirm their attendance (or indicate they will not attend). Similarly, participants can configure reminder parameters to control or limit how reminders are received, such as to restrict receipt of reminders to within a particular time before the event (e.g., 1 day, 2 days, 1 week, etc.), to restrict the number of reminders received (e.g., 1 reminder, 2 reminders, etc.) for a given event for which the user (attendee) has been scheduled to attend, or other types of parameters for controlling how reminders are provided to attendees or prospective attendees (e.g., users who have not confirmed attendance of an event). Where a conflict occurs between the parameters configured by the event creator and an attendee, the message handler may be configured with conflict resolution logic to resolve the conflict. For example, where event reminder parameters specify parameters should be sent 1 week before and 1 day before, but the attendees reminder parameters restrict reminders to only a single reminder, the conflict resolution logic of the message handler may forego transmitting the reminder 1 week before the event and instead send the attendee only the reminder scheduled for the day before the event. It is noted that the exemplary reminder parameters and conflict resolution techniques described in the example above have been provided for purposes of illustration, rather than by way of limitation and that embodiments of the present disclosure may utilize other parameters to manage and control the flow of prompts and responses, including reminders.

In addition to the examples above, the natural language processing functionality of the machine learning engine may be configured to extract additional types of contextual or intent information from responses received from users during scheduling of events. For example, suppose a response is received that states “Sorry. I am traveling and can we catch up in mid December?” When parsing this message, the machine learning engine may extract an intent that indicates the user is requesting (i.e., a “Request Intent”) to reschedule (i.e., a “Scheduling Intent”) a proposed event. The machine learning engine's natural language processing functionality may also extract scheduling parameters that indicate the event should be rescheduled for “mid December”, indicating the user would like to reschedule the meeting for some time in the middle of December. The machine learning engine may pass the extracted features and scheduling parameters to the message handler for further processing, such as to coordinate with the scheduling engine to determine when in December the meeting or event should be rescheduled, and to transmit a prompt to the user proposing a new date and time for the rescheduled event. For example, the prompt may include a message such as “Happy to reschedule for mid-December. How does 3:00 PM CST on December 16th sound?” The particular date and time proposed in the prompt may be determined based on information accessible to the scheduling engine, such as information associated with one or more users' calendars or schedules, as well as scheduling logic that may be configured to interpret vague scheduling parameters such as “mid December”. As an example, the scheduling logic may be configured with logic to associate the middle of a given month with a particular date or range of dates (e.g., the middle of December may be December 15th, or may be any available day between December 12th and December 18th). The scheduling logic may be configured to handle other types of relative scheduling terms, such as “early next [week/month]”, “towards the end of the day/week/month”, “later today”, or “later this week/month/year” based on pre-defined date ranges and/or times (e.g., early next month may indicate the first week of the next month, later today may indicate X hours from the time the message was received or prior to 5 PM in the relevant time zone, etc.)

The scheduling logic may pass a set of configured scheduling parameters to the message handler based on the outputs of the scheduling logic, where the set of configured scheduling parameters may include a date and time determined by the scheduling logic. It is noted that where the scheduling parameters extracted by the machine learning engine do not include relative or vague terms, such as those described above, the set of configured scheduling parameters may be the same as the extracted scheduling parameters. For example, if the scheduling parameters extracted by the machine learning engine indicate a request to schedule or reschedule an event at a specific date and time (e.g., Jun. 28, 2023, at 5:00 PM CST), the set of configured scheduling parameters may be the same. In such instances, the message handler may include logic to determine whether the extracted scheduling parameters include relative terms that require analysis by the scheduling logic. If no relative or vague terms are found, the message handler may analyze the intent(s) features to determine the type of response that should be sent in the next prompt provided by the user, retrieve an appropriate response template (e.g., as described above with reference to FIG. 2A), and create the prompt. If vague or relative terms are identified however, the extracted scheduling parameters may be passed to the scheduling engine for analysis and the prompt may be generated based on the specific date and time output by the scheduling logic as described above.

It is noted that in the example above, where the response being analyzed was “Sorry. I am travelling and can we catch up in mid December?”, the intent to request to reschedule may be inferred based on the phrase “can we catch up in mid December?”, rather than on the phrase “I am travelling”. For example, Table 1 also includes a response “I will be travelling next week but will be zoomed in on Tuesday for out meeting.” In this example similar language (e.g., “I will be travelling next week”) is present, but instead of including language requesting to catch up at a later time (i.e., the middle of December), this message indicates the user “will be zoomed in on Tuesday for our meeting.”, which indicates the user is confirming plans to attend the meeting on Tuesday. As compared to the prior example, the natural language processing logic of the machine learning engine may be configured to extract the intent to confirm the meeting based on the different in the overall context of the second message (e.g., that the message indicates the user is “zoomed in” for the meeting, rather than including the terms such as “catch up”).

As another example, suppose a response with a message “I'm out of office and traveling with limited access the week of December 19th. I will respond to messages intermittently throughout the week.” is received by the message handler. In this example from Table 1 the natural language processing of the machine learning engine may determine that the message involves features of “Other” intent, and “No Action” scheduling intent because the message does not include language indicative of a meeting or scheduling a meeting. For example, unlike the prior two examples which included the phrases “catch up in mid December” and “zoomed in on Tuesday for our meeting.”, this message merely indicates the user is travelling without conveying any intent to schedule a meeting or confirm attendance or non-attendance of an event. In particular, the natural language processing may determine the date information (e.g., December 19th or the week of December 19th) is provided in associated with the phrase “I'm out of office and travelling” to determine that the date information relates to when the user is travelling, rather than being associated with scheduling an event. In such instances, the message handler may determine that no action is needed or may schedule a reminder (e.g., a reminder to confirm attendance of an event or a reminder of an event the user is confirmed as attending) to be sent following the user's return (i.e., the week following the week of the 19th or another time close to a scheduled event) in accordance with any configured reminder parameters, as described above.

An additional feature provided by the natural language processing functionality of the machine learning logic, as well as the message handler and scheduling engine, is the ability to add users as target recipients of messages in connection with scheduling of events. For example, in Table 1 the message “Thank you for the note. John is travelling overseas so an intro call may be best in early December. We'll check-in towards the end of the month and see if we can find some time for an intro call.” may be received from a user. The natural language processing may parse this message and detect that John is another potential party that should be scheduled for the event. Based on the phrase “We'll check-in towards the end of the month” it may be determined that this message is a request to reschedule the event for “early December”. Based on this information, the message handler may query the scheduling engine to resolve the meaning of “early December” and schedule transmission of a reminder to follow up with the user about the meeting. When configuring the reminder for transmission, a template may be selected that includes appropriate language for adding a new user to the event, such as a template that includes language such as “Following up on our prior discussion, were you able to find some time for an introductory call with John?” As another non-limiting example, Table 1 includes a message “I am out of office till 5th may. Please contact later or reach out to user@example.com”. In parsing this message using natural language processing, features indicating the message is a request to reschedule a meeting may be identified, as described above. Additionally, the phrase “reach out to user@example.com” may be identified a request to invite additional users to the meeting (e.g., since contact information is provided). In such instances, the message handler may transmit a message to the new user associated with the contact information specified in the message to see if the new user can be scheduled for the event prior to the 5th of May (i.e., the time period where the original user is out of office and unavailable to attend the event).

The message handler and scheduling logic may also be configured to handle scheduling parameters that indicate multiple potential time frames for a meeting. For example, in Table 1 a message states “How about next Thursday afternoon? Or Wednesday?” and another message states “a meeting October 17-21 (Between 11:00 AM PST & 3:00 PM PST)”. When handling these messages, the scheduling logic may select an optimal time for the meeting based on various types of data. For example, suppose that there are a significant number of appointments on Thursday, or on October 17th and 18th, which may result in limited time or the potential for missing or being late to the meeting (e.g., if a prior appointment runs long). In such instances, the scheduling logic may utilize other functionality of the machine learning engine to identify the optimal date and time for the event based on the dates included in the extracted scheduling parameters. The machine learning engine may determine the optimal time based on a variety of factors, such as the number of participants to the meeting, any times proposed for the meeting (e.g., dates, times, time ranges, etc.), prior scheduled events proximate to the proposed times involving the same persons, whether additional personnel are available to participate in the meeting (e.g., as a substitute for another potential participant), or other factors. For example, suppose the automated scheduling process is scheduling a meeting with an employee of a company with potential customers. If there are no employees available (e.g., based on their scheduling information), the machine learning logic may determine whether to choose an alternative time or date for the meeting, or may determine to schedule an additional employee to attend the meeting at a given date and time, as described herein with reference to FIGS. 2A and 2B. Once the optimal scheduling parameters are determined, the scheduling engine may pass the set of scheduling parameters to the message handler where they may be used to generate a prompt proposing to schedule the event at the optimal time determined by the machine learning logic.

As yet another example, the message handler may be configured to detect when a user has declined attending an event. For example, the message of Table 1 stating “Thanks Dennis and PK. I am traveling today and will not be able to participate.” may be analyzed to extract intent features and it may be determined that this message indicates a particular user will not be able to attend the event. In such instances, the message handler may determine an appropriate template for thanking the user for confirming their status for the event and may pass information to the scheduling engine to update the list of attendees to indicate the user will not be attending the event.

As shown above, systems in accordance with the present disclosure (e.g., the system 100 of FIG. 1) may leverage functionality of a machine learning engine (e.g., the machine learning engine 120 of FIG. 1), a message handler (e.g., the message handler 122 of FIG. 1), and a scheduling engine (e.g., the scheduling engine 124 of FIG. 1) to support automated interactive chat sessions in which messages associated with scheduling or rescheduling events may be conducted with users without requiring a human to participate in the process of generating the messages exchanged during the chat session.

To further illustrate the exemplary functionality described above with regard to the messages shown in Table 1, FIG. 3A shows a block diagram illustrating aspects of providing dynamic and interactive scheduling in accordance with of the present disclosure is shown as a process 300A. In an aspect, the process 300A supports operations for providing a dynamic and interactive dialogue driven by artificial intelligence functionality to provide scheduling of events. The process 300A may be supported by a machine learning engine, a message handler, and a scheduling engine, such as the machine learning engine 120, the message handler 122, and the scheduling engine 124, as well as other examples described herein. In the non-limiting example shown in FIG. 3A, the process 300A provides functionality that supports a chat-style interactive dialogue for scheduling events in which a computing device (e.g., the computing device 110 of FIG. 1) provides prompts (e.g., messages), shown in FIG. 3A as prompts 302, 306, 310, to a user (e.g., an operator of the user device 140 of FIG. 1) and the user provides responses, shown in FIG. 3A as responses 304, 308, to the computing device.

The initial prompt 302 may include event data associated with one or more proposed events. For example, the initial prompt 302 may be transmitted to a user and propose a particular date and time (or multiple dates and times) for scheduling a meeting at for the user. As explained above with reference to FIG. 2A and Table 1, the initial prompt 302 and any subsequent prompts may be transmitted (e.g., as one or more messages 204 of FIG. 2A) and the response(s) returned by the user via the user device may be received as input messages (e.g., the one or more messages 202 of FIG. 2A). To illustrate, in the sequence shown in FIG. 3A, the user may transmit a response 304 subsequent to receiving the initial prompt at the user device. The response 304, once received by the message handler, may be passed to the machine learning engine to extract context and intent information from the response, as explained above with reference to Table 1. In the example of FIG. 3A, the features extracted from the response 304 may indicate the user has requested to reschedule the meeting and may include scheduling parameters proposing a different date and/or time.

As explained above, the features and scheduling parameters extracted (e.g., via natural language processing functionality of the machine learning engine) from the response 304 may be provided to the message handler where they may be used to configure a new prompt, shown in FIG. 3A as prompt 306. The prompt 306 may include revised scheduling information for the proposed meeting and may be provided in a message based on a template obtained from a template database (e.g., one of the databases 118 of FIG. 1 or 230 of FIG. 2A). In an aspect, the revised scheduling information may be provided by the scheduling engine and may be determined, at least in part, by machine learning logic provided by the machine learning engine, as explained above with reference to Table 1.

The user may receive the prompt 306 containing the revised scheduling information and may reply with a response 308 that confirms the user will (or will not) attend the meeting associated with the revised scheduling information. Where the response 308 confirms attendance of the meeting, the message handler may schedule transmission of at least one additional prompt 310 to the user, such as a prompt reminding the user of the scheduled meeting. As explained above, the message handler may utilize reminder parameters to control when reminders are sent, as well as how many reminders are sent, and may include conflict resolution logic to resolve conflicts between reminder parameters configured by an event creator and an event attendee. It is noted that the exemplary exchange of messages shown in FIG. 3A may be performed during an interactive chat session, such as via an application, widget, mobile application, web application, or other method, in which a prompt is provided to the user and the user responds some time thereafter. In such a scenario, the chat session appears to the user as if a human is generating the prompts 302, 306, 310, which may be facilitated, at least in part, by functionality of the message handler to create the prompts automatically as the responses 304, 308 are received. Additionally, the human-like chat experience (e.g., from the perspective of the user/potential attendee) may be facilitated through extraction of features via natural language processing, which enables the message handler to track the context of the messages exchanged during the interactive session and enables templates relevant to a current context of the messages being exchanged to be selected when generating a next prompt to the user (e.g., create prompts that appear to be responses typed by a human based on the last response from the user). In an aspect, there may be multiple different phrasing for a single type of prompt (e.g., several prompts to confirm or propose a time and date for a meeting), which may create some randomness in the feel of the system and create a more human-like feel as compared to if every response has a same structure or content for a given context. For example, a first confirmation message may be “Thank you for confirming your attendance of the meeting scheduled on Jul. 26, 2023, at 3:30 EST.” and a second confirmation message may be “Your attendance of the meeting on July 26th at 3:30 EST has been confirmed. We look forward to meeting with you.” It is noted that the exemplary exchange of prompts and responses shown in FIG. 3A has been provided for purposes of illustration, rather than by way of limitation and that more complex exchanges of messages may be facilitated using the concepts disclosed herein, such as various ones of the techniques described above with reference to FIG. 2A and the exemplary processing capabilities described above with reference to Table 1. Accordingly, it is to be understood that systems operating in accordance with the present disclosure may provide dynamic and interactive chat sessions involving more complex message exchanges than that shown in FIG. 3A.

In addition to supporting chat-style interactive sessions, as shown in FIG. 3A, the message handler may also be configured to support other types of interactive communications for scheduling events. For example, and referring to FIG. 3B, a block diagram illustrating additional aspects of providing dynamic and interactive scheduling in accordance with of the present disclosure is shown as a process 300B. Unlike process 300A, which supports interactive-chat-style sessions, the process 300B may support scheduling of events through interactive e-mail messaging. The process 300B may leverage many of the techniques used by the process 300A described above, such as using natural language processing functionality of the machine learning engine to extract features and scheduling parameters that may be used to determine the intent of the user (e.g., whether the user is requesting to reschedule an event, confirm attendance of an event, decline attendance of an event, identify other users that should be contacted in connection with an event, etc.), however, extraction of such features may require some additional analysis by the natural language processing functionality.

For example, in FIG. 3B a sequence of e-mails equivalent to the interactive chat session of FIG. 3A is shown and includes e-mails 320, 322, 324, 326, 328, where e-mail 320 may be equivalent to the prompt 302, e-mail 322 may be equivalent to the response 304, e-mail 324 may be equivalent to the prompt 306, e-mail 326 may be equivalent to the response 306, and e-mail 328 may be equivalent to the prompt 310. The e-mails 320-328 include headers, shown in FIG. 3B as 320h, 322h, 324h, 326h, 328h containing contact information (e.g., the sender and recipients of the e-mail), time information (e.g., the time the e-mail was sent), a subject line, and potentially other information. Additionally, the e-mails 320-328 include a body portion, shown in FIG. 3B as 320b, 322b, 324b, 326b, 328b containing the messages related to scheduling or rescheduling of events. For example, the body portions 320b, 322b, 324b, 326b, 328b for each of the e-mails 320-328 may contain the messages described above with respect to the prompts 302, 306, 310 and responses 304, 308 of FIG. 3A.

The presence of the headers may present some additional complexity that must be accounted for by the natural language processing as compared to just look. For example, as explained above with reference to Table 1, a response by a user may indicate another user should be contacted or included on communications regarding an event being scheduled. Additionally, each e-mail message transmitted may include all prior e-mail messages in the e-mail chain (e.g., e-mail 320 may be a single e-mail, but e-mail 322 include e-mail 320, e-mail 324 includes e-mails 320, 322, and so on). Thus, as the e-mail chain grows longer, the amount of noise that needs to be filtered by the natural language processing may increase. To illustrate, when analyzing the e-mail 322 the natural language processing should evaluate the body portion 322b of the e-mail 322 but need not use the header 320h or the body portion 320b of e-mail 320 to determine the intent or extract features from the e-mail 322. Additionally, the mere presence of e-mail addresses in the headers of the e-mail 320, 322 does not automatically indicate new people are being identified as needing to be invited to an event being scheduled.

To address the above-described differences between the chat-style and e-mail sequences of communications, the natural language processing may utilize some additional analysis techniques to filter out extraneous information from the e-mails being analyzed. To illustrate, the natural language processing may be configured to detect headers within e-mails based on identification of a set of e-mail addresses followed by a subject line (e.g., a string of text and numerical data). The natural language processing may be configured to ignore (e.g., as noise) the headers of the e-mail and any subsequent e-mails and identify the body of the e-mail (i.e., the portion of the e-mail from which the current analysis should begin). This is because the original e-mail may be configured with one or more e-mail addresses of the target attendee(s) for the event to be scheduled, as well as an e-mail address used by the message handler to transmit e-mails to the target attendee(s).

However, where a new e-mail address (i.e., one not previously included in the e-mail chain) is detected, it may be unclear whether this new e-mail address is a new potential attendee, or just someone being copied for awareness (e.g., of the event, the fact that the user may participate in the event, etc.), such as an administrative assistant or other individual. Thus, the natural language processing may seek to identify contextual information in the body of the most recent e-mail (i.e., the e-mail in which the new e-mail address was found) to indicate whether the new e-mail address is a new potential attendee or not. For example, as explained above with reference to Table 1, if the message includes phrases such as “introduction to User_X” or “User_X might find this event helpful or interesting” the natural language processing may compare “User_X” to the e-mail address to see if the e-mail address appears to be related to “User_X”. If related, User_X may be identified as a new candidate attendee and may be included in future e-mail communications. However, if these two pieces of information do not appear to be related (e.g., based on analysis of the name of User_X and the e-mail address or other semantic information included in the body of the e-mail), User_X may not be identified as a new candidate attendee and the e-mail address may be treated as noise. Alternatively, the natural language processing may merely generate a vectorized and tokenized (e.g., numerical) representation of the e-mail and a machine learning model trained to predict whether a message is indicating new attendees for an event may be used to detect whether a received message identifies new event attendees that should be added to messages related to an event.

As shown above, the processes 300A and 300B of FIGS. 3A and 3B provide functionality to support different types of dynamic and interactive sessions for scheduling events. Both processes 300A and 300B leverage natural language processing techniques provided by a machine learning engine to extract features and scheduling parameters from responses to messages generated by a message handler of a scheduling system, thereby facilitating dynamic and interactive scheduling of events with users in a manner that is fully automated (e.g., from the scheduling system side) but creates the appearance that human interaction is involved from the user/target attendee perspective. It is noted that while designed to facilitate generation and transmission of automatic prompts to the users, in an aspect there may be human involvement in at least some instances or situations. For example, a response may be received for which no features may be extracted or the features (e.g., intent(s)) are unclear in terms of their meaning (e.g., some language in the message indicates a rescheduling request and other language indicates a different intent). In such situations the response may be escalated to an escalation specialist for clarification on how further processing should be handled. During escalation to the specialist the message may be presented to the escalation specialist who may determine the intent that should be utilized to respond to or otherwise address the response message. The intent may then be passed to the message handler for further processing (e.g., in the same manner as if the intent had been able to be extracted by the natural language processing).

In an aspect, any responses that are escalated to the escalation specialist to confirm the intent may be stored in a database (e.g., one of the one or more databases 118 of FIG. 1) as training data. The intent determined during the escalation may also be stored with the response and may serve as labelled training data that may be used to further train the natural language processing and other functionality of the machine learning engine. This labeled training data may enable the natural language processing functionality of the machine learning engine to correctly extracted features that may be used to determine intent from similar responses in the future, thereby enabling further automation of the processes 300A, 300B through the ability to handle more types of responses without requiring escalation to extract intent.

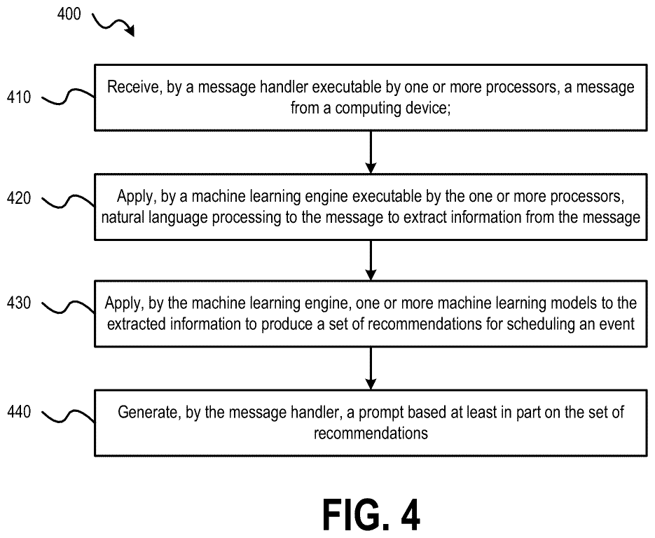

Referring to FIG. 4, a flow diagram illustrating an exemplary method for providing a blockchain platform in accordance with embodiments of the present disclosure is shown as a method 400. In an aspect, the method 400 may be performed by an entity device, such as the entity device 110 of FIG. 1. Steps of the method 400 may be stored as instructions (e.g., the instructions 116 of FIG. 1) that, when executed by one or more processors (e.g., the one or more processors of FIG. 1), cause the one or more processors to perform the steps of the method 400.

At step 410, the method 400 includes receiving, by a message handler executable by one or more processors a message from a computing device. In an aspect, the message handler may be the message handler 122 of FIG. 1 or the message handler 200 of FIG. 2A.

At step 420, the method 400 includes applying, by a machine learning engine executable by the one or more processors, natural language processing to the message to extract information from the message. In an aspect, the machine learning engine may be the machine learning engine 120 of FIG. 1 or the machine learning engine 270 of FIG. 2B. As explained, the extracted information obtained via the natural language processing may include a set of features (e.g., intent information, etc.), one or more scheduling parameters (e.g., date and/or time information), or both. Other information may also be extracted by the natural language processing in some aspects, such as attendee information, contextual information (e.g., information relevant to whether the message is identifying new potential attendees for an event, etc.).

At step 430, the method 400 includes applying, by the machine learning engine, one or more machine learning models to the extracted information to produce a set of recommendations for scheduling an event. As explained herein, the set of recommendations may include recommended dates and/or times for scheduling an event, locations for an event, personnel to host the event, or other types of recommendations regarding an event. As described above with reference to FIG. 2B, the machine learning engine may also provide functionality for validating the set of recommendations based on one or more validation criteria. In response to a determination that the set of recommendations are invalid, a new set of recommendations may be obtaining using the one or more machine learning models based on the extracted information. Optionally, the new set of recommendations may also be obtained based on one or more negative parameters, such as parameters indicating invalid dates and/or times for the event, as described above.

At step 440, the method 400 includes generating, by the message handler, a prompt based at least in part on the set of recommendations. In an aspect, the prompt may be generated based on a template selected from a templates database, as described above with reference to FIG. 2A. The prompt may include natural language text corresponding to at least a portion of the set of recommendations for scheduling the event. For example, the selected template may include pre-generated text and fields that may be populated based on the set of recommendations, as explained above with reference to FIGS. 2A, 3A, 3B, and Table 1. As explained above, once the prompt is generated, it may be transmitted to the computing device. In some aspects, multiple prompts may be generated using the method 400, such as to facilitate an interactive chat session for scheduling an event or to reply to e-mails in an e-mail chain automatically.

In some aspects, a response to the prompt may be received, as described above with reference to FIGS. 3A and 3B and Table 1. When a response to a transmitted prompt is received, the natural language processing and at least one machine learning model may be applied to the response to the prompt to extract additional features and determine recommendations for replying to the response with another prompt. For example, a response to a prompt may be analyzed to determine whether the response to the prompt confirms attendance of an event. In some aspects, prompts may also be generated without receiving a message, such as to transmit reminders about scheduled events.

When attendance of an event is determined to be confirmed, the method 400 may also be configured to create a record in a database in response to detection that the response to the prompt confirms attendance of the event. For example, when it is determined that a user has confirmed attendance of an event, information associated with the confirmation may be provided to a scheduling engine (e.g., the scheduling engine 124 of FIG. 1), which may store information associated with the confirmation in an events database, wherein the record comprises information associated with at least a venue for the event, a time for the event, and attendee information for the event.

It is noted that the method 400 may include additional operations and functionality described herein with reference to FIGS. 1-3B. As shown above, the method 400 enables dynamic scheduling of events to be performed in an automated manner. In particular, the method 400 supports dynamic messaging via chat-style and e-mail communication sessions to perform operations for scheduling events. As explained herein, the templates used in some examples to generate prompts may include multiple templates for each type of prompt (e.g., invitations to events, messages to reschedule events, etc.) to vary the appearance of the prompts and create the appearance they were created by a human, rather than through the automation techniques disclosed herein. The machine learning engine is used to optimize parameters for events, such as time, date, location, host, and other parameters of an event. Additionally, the recommendations output by the machine learning engine may be validated prior to selection of any of the recommendations to ensure secondary considerations are accounted for, such as an ability to staff an event, event preferences, and the like. Using the method 400 and the concepts described herein provides for more efficient use of computing resources (e.g., reduced network bandwidth, lower memory and computational processing requirements for message generation, etc.). The method also enables optimization of messages associated with scheduling events and improves event attendance.

It is noted that while primarily described as facilitating automated generation of messages in connection with scheduling events, in some aspects, the above-described functionality may be provided in other scenarios. For example, when a user needs to schedule an event, the above-described processes may be used to present proposed scheduling parameters (e.g., dates, times, locations, etc.) to a graphical user interface, such as to a scheduling person attempting to schedule an event. Such process may eliminate time consuming tasks (e.g., looking manually through an event schedule, staffing schedule, etc.) to determine availability for scheduling an event. The above-described processes may also enable scheduling of staff to host events being scheduled and in doing so, may implement policies of an entity with respect to staffing of events, such as to enforce a random, round robin, least busy, or other policy (e.g., customer requested host), and integrate with a staffing application to schedule appropriate staff for scheduled events (e.g., whether events are scheduled by a user manually or automatically based on recommendations provided in accordance with the processes disclosed herein). Where a new customer is detected, the above-described processes may attempt to correlate any known data points (e.g., demographics, location, etc.) of the new customer with known customers of the entity until additional data is obtained that may be used in scheduling events.

In an aspect, the above-describes systems and methods may utilize entity-specific models. For example, different entities may each have a set of models trained on their own datasets, thereby ensuring that scheduling predictions are optimized on a per-entity basis. Such feature may ensure data privacy between different entities, as well as account for how customers may have different preferences for different entities and/or types of services provided by each entity. In an aspect, prompt templates may be branded for each entity to provide customized messaging in connection with utilizing the techniques described herein for event scheduling, such as to incorporate an entity's logo, address, links (e.g., to a homepage of the entity's website), or other customizable features.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules described herein (e.g., the functional blocks and modules in FIGS. 1-4) may comprise processors, electronics devices, hardware devices, electronics components, logical circuits, memories, software codes, firmware codes, etc., or any combination thereof. In addition, features discussed herein relating to FIGS. 1-4 may be implemented via specialized processor circuitry, via executable instructions, and/or combinations thereof.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed embodiment, the term “substantially” may be substituted with “within a percentage of” what is specified, where the percentage includes 0.1, 1, 5, and 10 percent; and the term “approximately” may be substituted with “within 10 percent of” what is specified. The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or. Additionally, the phrase “A, B, C, or a combination thereof” or “A, B, C, or any combination thereof” includes: A alone, B alone, C alone, a combination of A and B, a combination of A and C, a combination of B and C, or a combination of A, B, and C.

The terms “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any implementation of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, it will be understood that the term “wherein” may be used interchangeably with “where.”

Further, a device or system that is configured in a certain way is configured in at least that way, but it can also be configured in other ways than those specifically described. Aspects of one example may be applied to other examples, even though not described or illustrated, unless expressly prohibited by this disclosure or the nature of a particular example.

Those of skill would further appreciate that the various illustrative logical blocks, modules, circuits, and algorithm steps (e.g., the logical blocks in FIGS. 1-4) described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

The above specification and examples provide a complete description of the structure and use of illustrative implementations. Although certain examples have been described above with a certain degree of particularity, or with reference to one or more individual examples, those skilled in the art could make numerous alterations to the disclosed implementations without departing from the scope of this invention. As such, the various illustrative implementations of the methods and systems are not intended to be limited to the particular forms disclosed. Rather, they include all modifications and alternatives falling within the scope of the claims, and examples other than the one shown may include some or all of the features of the depicted example. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several implementations.

The claims are not intended to include, and should not be interpreted to include, means plus- or step-plus-function limitations, unless such a limitation is explicitly recited in a given claim using the phrase(s) “means for” or “step for,” respectively.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A system comprising:
a memory;
one or more processors communicatively coupled to the memory;
a message handler executable by the one or more processors;
a machine learning engine executable by the one or more processors;
wherein the message handler is configured to:
receive a message from a computing device; and
pass the message to the machine learning engine for analysis;
wherein the machine learning controller is configured to:
apply natural language processing to the message to extract information from the message, the extracted information comprising a set of features, one or more scheduling parameters, or both;
apply one or more machine learning models to the extracted information to produce a set of recommendations for scheduling an event; and
provide the set of recommendations for scheduling the event to the message handler,
wherein the message handler generates a prompt based at least in part on the set of recommendations and transmits the prompt to the computing device.

2. The system of claim 1, wherein the message handler is configured to support interactive chat sessions and e-mail communications.

3. The system of claim 2, wherein the message comprises a chat message received during an interactive chat session and the prompt comprises a reply chat message, or the message comprises an e-mail message and the prompt comprises a reply e-mail.

4. The system of claim 1, wherein the message handler is configured to receive a response to the prompt, and wherein the machine learning engine is configured to:
apply the natural language processing and at least one machine learning model to the response to the prompt; and
analyze outputs of the at least one machine learning model to determine whether the response to the prompt confirms attendance of an event, and
wherein the system comprises a scheduling engine configured to create a record in a database in response to detection that the response to the prompt confirms attendance of the event, wherein the record comprises information associated with at least a venue for the event, a time for the event, and attendee information for the event.

5. The system of claim 1, wherein the message handler is configured to identify, based on the set of recommendations, a new candidate attendee for the event, wherein the prompt is transmitted to a second computing device corresponding to the new candidate attendee.

6. The system of claim 1, wherein the machine learning engine is configured to:
validate the set of recommendations based on one or more validation criteria; and
in response to a determination that the set of recommendations are invalid, obtaining a new set of recommendations from the one or more machine learning models, wherein the new set of recommendations are obtained from the one or more machine learning models based on the extracted information and one or more negative parameters.

7. A method comprising:
receiving, by a message handler executable by one or more processors a message from a computing device;
passing, by the message handler, the message to the machine learning engine for analysis;
applying, by a machine learning engine executable by the one or more processors, natural language processing to the message to extract information from the message, the extracted information comprising a set of features, one or more scheduling parameters, or both;
applying, by the machine learning engine, one or more machine learning models to the extracted information to produce a set of recommendations for scheduling an event; and
generating, by the message handler, a prompt based at least in part on the set of recommendations, wherein the prompt comprises natural language text corresponding to at least a portion of the set of recommendations for scheduling the event; and
transmitting, by the message handler, the prompt to the computing device.

8. The method of claim 7, wherein the message comprises an e-mail message and the prompt comprises a reply e-mail.

9. The method of claim 7, wherein the message comprises a chat message and the prompt comprises a reply chat message.

10. The method of claim 7, further comprising:
receiving a response to the prompt;
applying the natural language processing and at least one machine learning model to the response to the prompt; and
analyzing outputs of the at least one machine learning model to determine whether the response to the prompt confirms attendance of an event.

11. The method of claim 10, further comprising creating a record in a database in response to detection that the response to the prompt confirms attendance of the event, wherein the record comprises information associated with at least a venue for the event, a time for the event, and attendee information for the event.

12. The method of claim 7, further comprising detecting, based on the set of recommendations, a new candidate attendee for the event, wherein the prompt is transmitted to a second computing device corresponding to the new candidate attendee.

13. The method of claim 7, further comprising:
validating the set of recommendations based on one or more validation criteria; and
in response to a determination that the set of recommendations are invalid, obtaining a new set of recommendations from the one or more machine learning models.

14. The method of claim 13, wherein the new set of recommendations are obtained from the one or more machine learning models based on the extracted information and one or more negative parameters.

15. A non-transitory computer-readable storage medium storing instructions that, when executed by one or more processors, cause the one or more processors to perform operations comprising:
receiving a message from a computing device;
passing the message to the machine learning engine for analysis;
applying natural language processing to the message to extract information from the message, the extracted information comprising a set of features, one or more scheduling parameters, or both;
applying one or more machine learning models to the extracted information to produce a set of recommendations for scheduling an event;
generating a prompt based at least in part on the set of recommendations, wherein the prompt comprises natural language text corresponding to at least a portion of the set of recommendations for scheduling the event; and
transmitting the prompt to the computing device.

16. The non-transitory computer-readable storage medium of claim 15, wherein the message comprises an e-mail message and the prompt comprises a reply e-mail.

17. The non-transitory computer-readable storage medium of claim 15, wherein the message comprises a chat message and the prompt comprises a reply chat message.

18. The non-transitory computer-readable storage medium of claim 15, further comprising:
receiving a response to the prompt;
applying the natural language processing and at least one machine learning model to the response to the prompt;
analyzing outputs of the at least one machine learning model to determine whether the response to the prompt confirms attendance of an event; and
creating a record in a database in response to detection that the response to the prompt confirms attendance of the event, wherein the record comprises information associated with at least a venue for the event, a time for the event, and attendee information for the event.

19. The non-transitory computer-readable storage medium of claim 15, further comprising:
detecting, based on the set of recommendations, a new candidate attendee for the event, wherein the prompt is transmitted to a second computing device corresponding to the new candidate attendee.

20. The non-transitory computer-readable storage medium of claim 15, the operations further comprising:
validating the set of recommendations based on one or more validation criteria; and
in response to a determination that the set of recommendations are invalid, obtaining a new set of recommendations from the one or more machine learning models, wherein the new set of recommendations are obtained from the one or more machine learning models based on the extracted information and one or more negative parameters.
